(19) United States
(12) Patent Application Publication
(10) Pub. No.: US 2023/0073225 A1
(43) Pub. Date: Mar. 9, 2023

(54) MARINE DRIVER ASSIST SYSTEM AND METHOD

(71) Applicant: Marine Canada Acquisition Inc., Richmond (CA)

(72) Inventors: Anson Chin Pang CHAN, Richmond (CA); Geoffrey David DUDDRIDGE, Nanaimo (CA); Declan George David MCINTOSH, Victoria (CA)

(21) Appl. No.: 17/799,148

(22) PCT Filed: Feb. 12, 2021
(86) PCT No.: PCT/CA2021/050156

§ 371 Date: Aug. 11, 2022

Related U.S. Application Data
(60) Provisional application No. 62/975,351, filed on Feb. 12, 2020.

(51) Int. Cl. B63B 49/00; G06V 20/64; G06V 10/82; G01S 13/42; G01S 13/86; G01S 13/937; G01S 17/86; G08G 3/02

(52) U.S. Cl. CPC B63B 49/00; G06V 20/64; G06V 10/82; G01S 13/42; G01S 13/865; G01S 13/867; G01S 13/937; G01S 17/86; G08G 3/02

(57) ABSTRACT

A driver-assist system for a marine vessel may include a camera operable to obtain data comprising images of a view of the camera, and a data processor. The data processor may be programmed to distinguish between portions of the view representing water and/or sky a portion of the view representing an object. The data processor may be programmed to detect an object by causing object detectors to search for objects in respective different subregions of the view. The data processor may be programmed to detect a boat in the view. The data processor may be programmed to cause the marine vessel to follow a detected boat.

### CROSS-REFERENCE TO RELATED APPLICATION

This application claims the benefit of, and priority to, U.S. provisional patent application No. 62/975,351 filed on Feb. 12, 2020, the entire contents of which are incorporated by reference herein.

### FIELD

This disclosure relates to driver assist systems and methods for marine vessels.

### RELATED ART

Driver assist systems for automobiles may not be suitable for marine vessels because, for example, lane markers are not typically encountered in a marine environment, and marine vessels typically do not follow each other in line as automobiles typically do on a road.

### SUMMARY

This disclosure provides, according to at least one embodiment, a driver assist system that may overcome such disadvantages. Embodiments of this disclosure may provide an improved driver assist system adapted for marine vessels.

There is accordingly provided, according to at least one embodiment, a system for obtaining and analysing information from its surroundings. The system includes a sensor for obtaining data from the surroundings and a data processor which receives data from the sensor and analyses the data to obtain relevant information. The data processor utilizes machine learning to process the data. The sensor may be a camera with the data images of the surroundings being taken by the camera.

The system may be installed on a marine vessel with the data processor being programmed to distinguish between portions of an image which represent sea and/or sky and a portion of the image representing an object near the marine vessel. The system disregards the portions which represent sea and/or sky and focuses on the portion representing the object.

There is further provided, according to at least one embodiment, a method for obtaining and analysing information from a surrounding view. A sensor is used to obtain data from the view. A data processor receives data from the sensor and analyses the data to obtain relevant information. The data processor utilizes machine learning to process the data. The sensor may be a camera and the data being images of the view are taken by the camera.

The system may be used for a marine vessel and distinguishes between portions of a view which represent sea and/or sky and a portion of the view representing an object near the marine vessel. The system disregards the portions which represent sea and/or sky and focuses on the portion representing the object.

There is further provided, according to at least one embodiment, a system for obtaining and analysing information from its surroundings, the system including a sensor for obtaining data from the surroundings and a data processor which receives data from the sensor and analyses the data to obtain relevant information, the data processor utilizing machine learning to process the data.

In some embodiments, the sensor is a camera and the data is images of the surroundings taken by the camera.

In some embodiments, the data processor is programmed to obtain information on objects in the surroundings.

In some embodiments, the system is adapted for installation on a marine vessel and the data processor is programmed to distinguish between portions of an image which represent sea and/or sky and a portion of the image representing an object near the marine vessel, the system disregarding the portions which represent sea and/or sky and focusing on the portion representing the object.

In some embodiments, the system can distinguish another boat from other objects in the surroundings.

In some embodiments, the system can determine a direction of movement of said another boat.

In some embodiments, the system interfaces with controls for said marine vessel to avoid collisions between said marine vessel and surrounding objects.

In some embodiments, the system includes adaptive cruise control.

There is further provided, according to at least one embodiment, a method for obtaining and analysing information in a surrounding view, the method including using a sensor to obtain data from the view, processing data from the sensor and analysing the data utilizing machine learning to obtain relevant information.

In some embodiments, the sensor is a camera and the data represents images of the view taken by the camera.

In some embodiments, the data is processed to obtain information on objects appearing in the view.

In some embodiments, the method is used for a subject marine vessel and the data is processed to distinguish between portions of the view which represent sea and/or sky and a portion of the view representing an object near the subject marine vessel, the system disregarding the portions which represent sea and/or sky and focusing on the portion representing the object.

In some embodiments, the system can distinguish another marine vessel from other objects in the surroundings.

In some embodiments, the method can determine a direction of movement of said another marine vessel.

In some embodiments, the method operates controls for said subject marine vessel to avoid collisions between said subject marine vessel and surrounding objects.

In some embodiments, images from the camera are segmented into different segments and, when another marine vessel is detected in one segment, the segment with said another marine vessel is prioritized during repeated cycles, thereby assisting in recognition of small vessels.

There is further provided, according to at least one embodiment, a system which obtains and analyses information from its surroundings. The system includes a sensor for obtaining data from the surroundings and a data processor receives data from the sensor and analyses the data to obtain relevant information. The data processor utilizes machine learning to process the data. The sensor may be a camera and the data images of the surroundings may be images taken by the camera. The system may be mounted on a boat and connected to the controls of the boat to assist navigation of the boat.

There is further provided, according to at least one embodiment, a driver-assist system for a marine vessel, the system comprising a camera operable to obtain data comprising images of a view of the camera. The system further comprises a data processor programmed to, at least, distinguish between: portions of the view representing water and/or sky; and a portion of the view representing an object.

In some embodiments, the data processor is further programmed to, at least, utilize machine learning trained to identify water, sky, and anything that is not water or sky.

In some embodiments, the data processor is further programmed to, at least, utilize a convolutional neural network trained to identify water, sky, and anything that is not water or sky.

In some embodiments, the data processor is further programmed to, at least, identify the object as anything that is not sky or water.

In some embodiments, the data processor is further programmed to, at least, adjust settings of the camera only according to image quality metrics values of only portions of the view not representing water and/or sky.

In some embodiments, the data processor is further programmed to, at least, identify a horizon in the view.

In some embodiments, the data processor is programmed to identify the object near the horizon.

In some embodiments, the data processor is further programmed to, at least, detect the object by, at least, causing at least some object detectors of a plurality of object detectors to search for objects only in respective different subregions of a plurality of different subregions of the view.

In some embodiments, the data processor is further programmed to, at least, cause the at least some object detectors to search for objects only in portions of the view not representing water and/or sky.

There is further provided, according to at least one embodiment, a driver-assist system for a marine vessel, the system comprising: a camera operable to obtain data comprising images of a view of the camera; and a data processor programmed to, at least, detect an object by, at least, causing at least some object detectors of a plurality of object detectors to search for objects only in respective different subregions of a plurality of different subregions of the view.

In some embodiments, the data processor is further programmed to, at least, implement the plurality of object detectors.

In some embodiments, at least one object detector of the plurality of object detectors is a single-shot detector (SSD).

In some embodiments, the plurality of subregions comprises a plurality of different predefined subregions.

In some embodiments, the predefined subregions of the plurality of predefined subregions are distributed evenly across the entire view.

In some embodiments, the predefined subregions of the plurality of predefined subregions overlap horizontally.

In some embodiments, the predefined subregions of the plurality of predefined subregions are centered vertically within the view.

In some embodiments, the data processor is further programmed to, at least: cause available object detectors of the plurality of object detectors to search only some predefined subregions of the plurality of predefined subregions in a first object detection cycle; and cause the available object detectors of the plurality of object detectors to search other predefined subregions of the plurality of predefined subregions in a second object detection cycle after the first object detection cycle.

In some embodiments, the data processor is further programmed to, at least, cause at least one object detector of the plurality of object detectors to search for objects in a dynamic subregion of the plurality of subregions, the dynamic subregion placed such that the object is within the dynamic subregion.

In some embodiments, the data processor is further programmed to, at least, cause the dynamic subregion to move in response to movement of the object.

In some embodiments, the data processor is further programmed to, at least, cause the dynamic subregion to have a size in response to a size of the object.

In some embodiments, the data processor is further programmed to, at least, cause at least one object detector of the plurality of object detectors to search for objects in the entire view.

In some embodiments, each object detector of the plurality of object detectors, in operation, detects objects at a resolution smaller than a resolution of the images.

In some embodiments, the data processor is further programmed to, at least, alert a user in response to detecting the object.

In some embodiments, the system is programmed to, at least, take collision avoidance measures in response to detecting the object.

In some embodiments, the system is programmed to take the collision avoidance measures by, at least, preventing the object from being less than a safety distance at any time from the marine vessel.

In some embodiments, the system is programmed to, at least, vary the safety distance according to, at least, a size of the marine vessel.

In some embodiments, the system is programmed to, at least, vary the safety distance according to, at least, a speed of the marine vessel.

In some embodiments, the system is programmed to, at least, vary the safety distance according to, at least, a size of the object.

In some embodiments, the system is programmed to, at least, vary the safety distance according to, at least, a speed of the object.

In some embodiments, the data processor is further programmed to, at least, identify a distance from the system to the object.

In some embodiments, the data processor is programmed to identify the distance from the system to the object according to, at least, radar data from a radar apparatus.

In some embodiments, the data processor is programmed to identify the distance from the system to the object according to, at least, lidar data from a lidar apparatus.

In some embodiments, the data processor is programmed to identify the distance from the system to the object according to, at least, data from a sensor separate from the camera.

In some embodiments, the data processor is further programmed to, at least, identify a speed of the object.

In some embodiments, the data processor is programmed to identify the speed of the object according to, at least, radar data from a radar apparatus.

In some embodiments, the data processor is programmed to identify the speed of the object according to, at least, lidar data from a lidar apparatus.

In some embodiments, the data processor is programmed to identify the speed of the object according to, at least, data from a sensor separate from the camera.

In some embodiments, the data processor is further programmed to, at least, identify a direction of movement of the object.

In some embodiments, the data processor is further programmed to, at least, identify a size of the object.

In some embodiments, the object is a detected boat.

There is further provided, according to at least one embodiment, a driver-assist system for a marine vessel, the system comprising: a camera operable to obtain data comprising images of a view of the camera; and a data processor programmed to, at least, detect a detected boat in the view.

In some embodiments, the data processor is further programmed to, at least, identify a direction of movement of the detected boat from a shape of the detected boat.

In some embodiments, the shape of the detected boat comprises a bow of the detected boat.

In some embodiments, the shape of the detected boat comprises a stern of the detected boat.

In some embodiments, the data processor is further programmed to, at least, identify one of a plurality of different classes of direction of movement in response to, at least, the direction of movement of the detected boat.

In some embodiments, the system is programmed to take the collision avoidance measures in response to, at least, the direction of movement of the detected boat.

In some embodiments, the system is programmed to, at least, cause the marine vessel to follow the detected boat.

In some embodiments, the system is programmed to, at least, cause the marine vessel to follow the detected boat at a set distance.

In some embodiments, the system is programmed to, at least, set the set distance according to, at least, a user-programmable follow sensitivity.

In some embodiments, the system is programmed to, at least, set the set distance according to, at least, a speed of the marine vessel.

There is further provided, according to at least one embodiment, a driver-assist system for a marine vessel, the system comprising: a sensor operable to obtain data from surroundings of the sensor; and a data processor programmed to, at least, cause the marine vessel to follow a detected boat.

In some embodiments, the sensor is a camera, and the data comprise images of a view of the camera.

In some embodiments, the data processor is programmed to cause the marine vessel to follow the detected boat only if the detected boat is a closest object detected by the system within an adaptive cruise control range.

In some embodiments, the data processor is programmed to cause the marine vessel to follow the detected boat only if the detected boat is at least a safe-following distance of the from the marine vessel.

In some embodiments, the data processor is programmed to cause the marine vessel to follow the detected boat only if the detected boat is moving in a same general direction as the marine vessel.

In some embodiments, the data processor is programmed to cause the marine vessel to follow the detected boat only if the system does not detect any risk of collision with other boats detected by the system.

In some embodiments, the data processor is programmed to cause the marine vessel to follow the detected boat only if the system does not detect any objects, other than the detected boat, within a safety region.

In some embodiments, the safety region is a safety circle.

In some embodiments, the data processor is programmed to cause the marine vessel to resume following the detected boat automatically in response to detecting no objects, other than the detected boat, within the safety region.

There is further provided, according to at least one embodiment, a marine vessel comprising the system.

Other aspects and features will become apparent to those ordinarily skilled in the art upon review of the following description of illustrative embodiments in conjunction with the accompanying figures.

### BRIEF DESCRIPTION OF THE DRAWINGS

Embodiments of this disclosure will be more readily understood from the following description of such embodiments given, by way of example only, with reference to the accompanying drawings, in which:

FIG. 1 is a diagrammatic, side view of a marine vessel equipped with an outboard motor and a driver assist system according to an embodiment;

FIG. 2 is a block diagram of a driver assist system for a marine vessel according to another embodiment;

FIG. 3 is an example of a view imaged by a camera of FIG. 2;

FIG. 4 is an example of a simplified view derived by the driver assist system of FIG. 1 from the view of FIG. 3 to separate objects from water and/or sky;

FIG. 5 is a block diagram showing a portion of the driver assist system of FIG. 1 that may be used to determine the direction of movement of adjacent vessels;

FIG. 6 is an example of a diagram of how the driver assist system of FIG. 1 may segment an image into different subregions, for example to better track smaller vessels;

FIG. 7 is a block diagram of the driver assist system of FIG. 1 for segmenting an image as shown in FIG. 6;

FIG. 8 is a block diagram showing details of detection cycles of the driver assist system of FIG. 1 for segmenting an image shown in FIG. 6 and FIG. 7;

FIG. 9 is an example of a view of a foreground segmentation of an image subject to brightness adjustment;

FIG. 10 is a block diagram illustrating a method by the driver assist system of FIG. 1 for adjusting brightness using the foreground segmentation of FIG. 9 as a mask;

FIG. 11 is a schematic diagram of an example of sensor fusion by the driver assist system of FIG. 1;

FIG. 12 is a simplified, diagrammatic plan view of the marine vessel of FIG. 1 with another small, slow-moving vessel approaching from the port side thereof;

FIG. 13 is a view similar to FIG. 12 but showing a large, slow-moving vessel approaching the marine vessel of FIG. 1 from port;

FIG. 14 is a view similar to FIG. 12 but showing a small, fast-moving vessel approaching the marine vessel of FIG. 1 from port;

FIG. 15 is a series of simplified views of examples of braking efforts on a marine vessel;

FIG. 16 is a block diagram showing a motion planner of the driver assist system of FIG. 1 including internal subunits and other components connected thereto;

FIG. 17 is a block diagram showing an adaptive cruise control engagement routine for an adaptive cruise control system of the driver assist system of FIG. 1;

FIG. 18 is a block diagram showing operation of the adaptive cruise control unit of FIG. 17;

FIG. 19 is a diagrammatic, plan view showing an angular range of adaptive cruise control according to one embodiment when the marine vessel of FIG. 1 is travelling at a relatively high speed and a target boat is relatively far away;

FIG. 20 is a view similar to FIG. 19 but showing an angular range of adaptive cruise control according to one embodiment when the marine vessel of FIG. 1 is travelling at a relatively low speed and the target boat is closer than in FIG. 19; and

FIG. 21 is a block diagram showing a machine learning model according to one embodiment.

### DETAILED DESCRIPTION

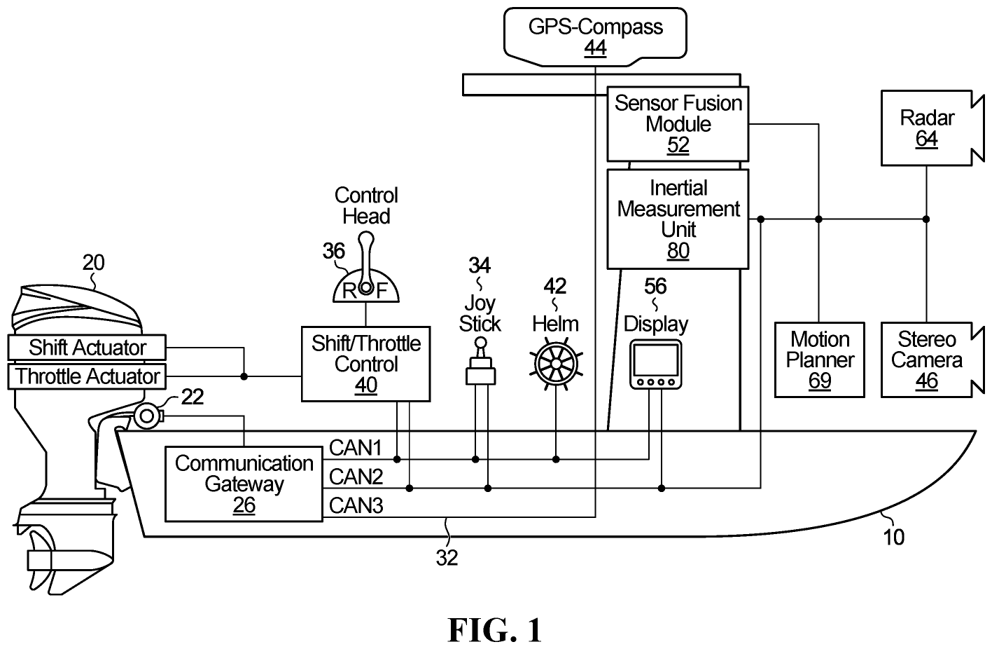

Referring to the drawings and first to FIG. 1, this is a schematic diagram of a marine driver assist system according to an embodiment. The diagram shows various standard controls of a marine vessel 10 which in this case are typical of a sports fishing vessel, including an outboard motor 20 with a steering actuator 22. There is a communication gateway 26 connected via a controller area network (CAN) bus 32 to various components including a joystick 34, control head 36, a shift and throttle controller 40, shift actuator, and throttle actuator. The vessel is steered via helm 42 and has navigational assist including a global positioning system (GPS) compass 44 and a stereo camera 46. There is a sensor fusion module 52 connecting to one or more sensing units including camera 46, radar 64, and inertial measurement unit (IMU) 80. There is a display 56 connected to the CAN bus 32 along with the motion planner 69 (which may also be referred to as a motion controller). However, marine vessels of alternative embodiments may differ and may include more, fewer, or different components.

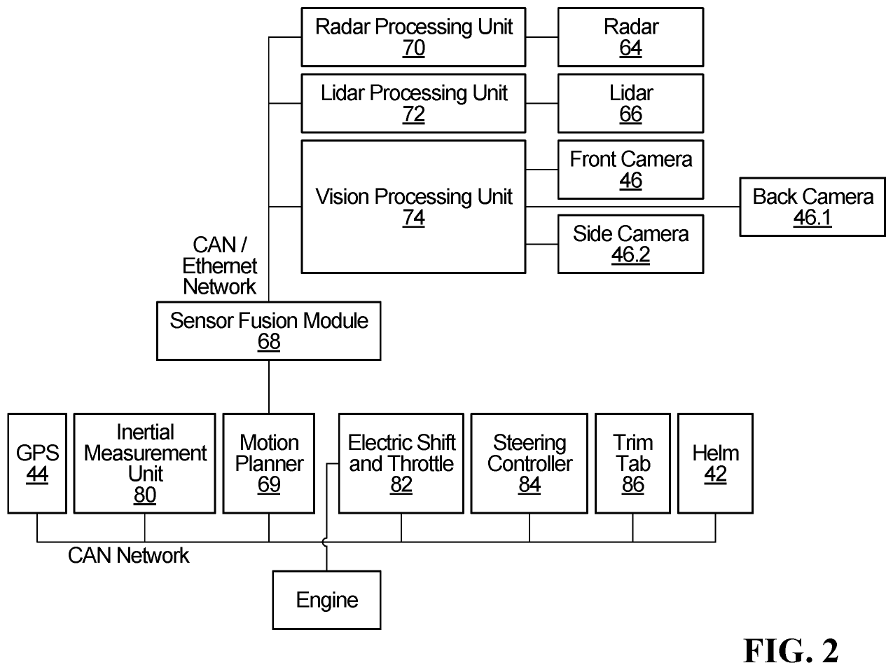

FIG. 2 is a block diagram of a similar driver assist system according to another embodiment with front camera 46 and additional components including a back camera 46.1, a side camera 46.2, radar apparatus 64, and lidar apparatus 66. All of these sensors are connected to sensor fusion module 68 (SFM). Radar apparatus 64 is connected to SFM 68 via radar processing unit 70 (RPU). Lidar apparatus 66 is connected to SFM 68 via lidar processing unit 72 (LPU). The front camera, back camera, and side camera are connected to module 68 via vision processing unit (VPU) 74. The sensor fusion module combines sensor data from the VPU, LPU, and RPU to gain perception and measurement data with respect to views surrounding the vessel. Camera, radar, and lidar information can all be used to create an image of the surroundings. Computer vision generally refers to the process or the result of one or a combination of these sensors. Motion planner unit (MPU) 69 uses tracking data from the SFM to generate appropriate shift, throttle, steering, and trim tab commands to control motion of the vessel. These are communicated to GPS 44, inertial measurement unit 80 (IMU), electric shift and throttle module 82, steering controller 84, trim tab 86 and helm 42. The IMU is an electronic device which measures and reports a body's specific force, angular velocity rate and optionally the orientation, or altitude, of the body using a combination of accelerometers, gyroscopes and, optionally, magnetometers. The VPU's, SFM and MPU are housed inside a computing processing unit, or are physically separated modules.

A driver assist system, as described herein for example, may include a data processor that may be programmed, configured, or otherwise operable to implement some or all functions of the driver assist system as described herein, for example. More generally, a driver assist system, as described herein for example, may be programmed, configured, or otherwise operable to implement some or all functions of the driver assist system as described herein, for example.

A driver assist system, a data processor, a unit, a module, a controller, or a system as described herein, for example, may include one or more processor circuits that may include one or more central processing unit (CPUs) or microprocessors, one or more machine learning chips, discrete logic circuits, or one or more application-specific integrated circuit (ASICs), or combinations of two or more thereof, for example, and that may include one or more of the same or different computer-readable storage media, which in various embodiments may include one or more of a read-only memory (ROM), a random access memory (RAM), a hard disc drive (HDD), a solid-state drive (SSD), and other computer-readable and/or computer-writable storage media. For example, one or more such computer-readable storage media may store program codes that, when executed, cause one or more processor circuits of a driver assist system, of a data processor, of a unit, of a module, of a controller, of a system, or of a combination of two or more thereof to implement functions as described herein, for example, in which case the driver assist system, the data processor, the unit, the module, the controller, the system, or the combination of two or more thereof may be programmed, configured, or operable to implement such functions. Of course a driver assist system, a data processor, a unit, a module, a controller, a system, or a combination of two or more thereof may be configured or otherwise operable to implement other functions and to implement functions in other ways.

A driver assist system, a data processor, a unit, a module, a controller, or a system as described herein, for example, may be implemented in the same device, such as a device including one processor circuit, or in one or more separate devices other implementations. For example, in some embodiments, the motion planner 69 and one or more other units, modules, controllers, systems, or a combination of two or more thereof as described herein may be implemented in one device including one processor circuit programmed, configured, or otherwise operable to implement some or all functions as described herein. In other embodiments, the motion planner 69 may be implemented in separate processor circuits or in multiple separate devices, and other units, modules, controllers, systems, or a combination of two or more thereof as described herein may be implemented in one device or in separate devices.

The marine driver assist system may utilize computer vision and machine learning to process the images received from the cameras such as camera 46, a stereo camera in this example, at the front of the craft shown in FIG. 1. A digital image received from, for example, camera 46 may be partitioned into multiple segments or pixels via image segmentation. The architecture used is a Convolutional Neural Network in this particular example, but other techniques of machine learning could be used. Repeated machine training may be employed on many different digital images that show marine objects, sky, and water. Herein, “water” may refer to an ocean, a sea, a lake, a river, or another body of water that the marine vessel 10 may operate on. The neural connection of the Convolutional Neural Network may thereby be trained to identify water, sky, and anything that is not water or sky.

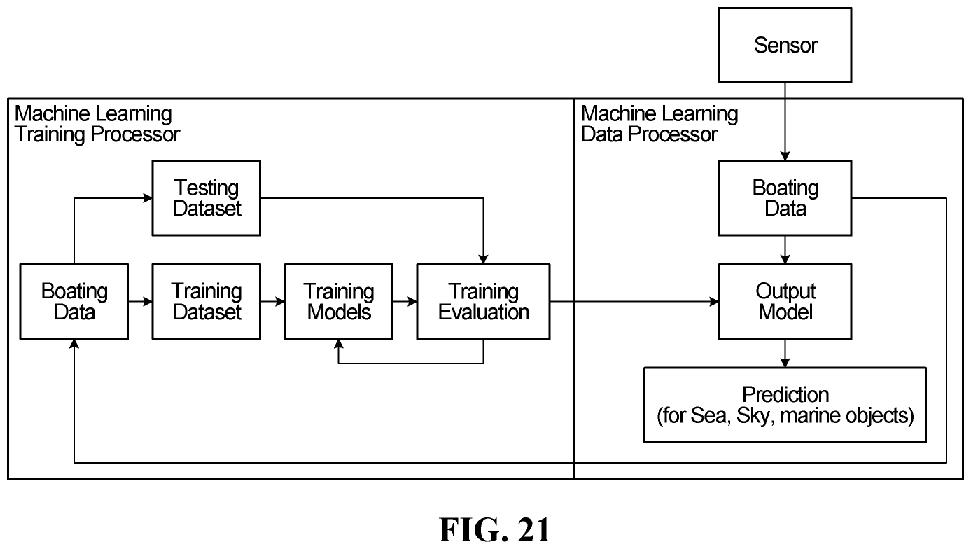

FIG. 21 shows an example of a machine learning model that can be used for computer vision in marine vessels. In the example of FIG. 21, a machine learning training process may be used to train the marine driver assist system to perform computer vision. Boating data (e.g. boating image data containing water, sky, boats, and other marine objects) may be separated into a training dataset and a testing dataset. The training dataset may be fed into machine training models, which may implement mathematical models and algorithms used to perform the machine training. The output of the training models may then go through a model evaluation phase that may help to find the best model that represents the data. The testing dataset, which may be unseen by the machine during its training, may also be fed into the model evaluation to verify the model and to help tune model parameters in an iterative process to improve prediction accuracy. The end result may be an output model that may be used in a machine learning data processor (or more generally in the marine driver assist system). The machine learning data processor may receive boating data from a sensor such as a camera. The boating data may contain typical objects seen in marine environment, and water and sky. The boating data may then be fed into the machine learning output model, which may then make predictions of water, sky, and other marine objects in the boating data.

The training may be simplified by focusing on objects that are neither sky nor water. Things that are not identified as sky or water may be deemed to be marine object candidates for a collision warning or avoidance. These objects could be a boat, buoy, shoreline, a bridge, a marker, a log, or a piling, for example.

By focusing on objects that are neither sky nor water, the processes of machine learning and real-time execution speed of image recognition may be accelerated. This method may also simplify the ground truth data annotation because there may be a reduction in the number of segmentation classes. Ground truth is a term used to refer to information provided by direct observation (i.e. empirical evidence) as opposed to information provided by inference. In some embodiments, such a system may be robust to classes of images that may not have been experienced before or which do not exist in training data. For example, a manatee may not have been experienced before, but the VPU may still recognize a manatee as an object which the boat may potentially collide with.

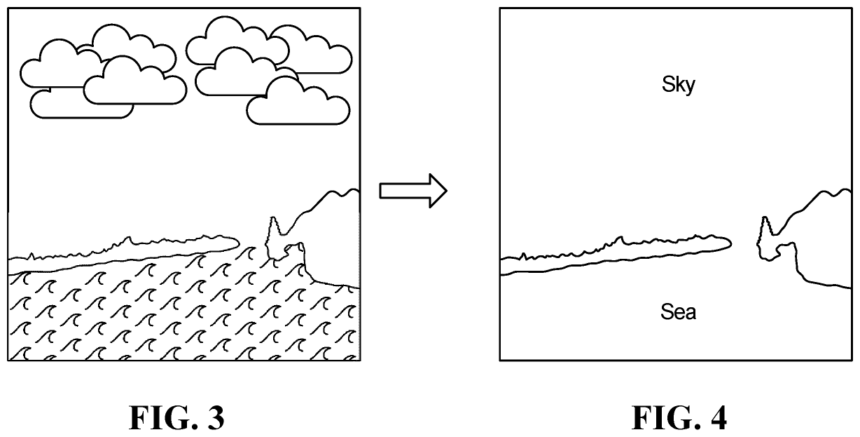

With reference to FIGS. 3 and 4, FIG. 3 shows an example of a view comprising part of the surroundings of the marine vessel. The trained module shows all regions of the image where only water or sky exist. The marine driver assist system then takes the inverse of this mask to generate a mask for all collidable objects, as shown in FIG. 4, which may be used for advanced driver assist functions.

The marine driver assist system may also utilize boat identification and tracking using computer vision and machine learning. In other words, the marine driver assist system may be capable of identifying boats which may be in a simplified image, similar to FIG. 4, containing sky and water and anything which is not sky and water and therefore is a potentially collidable object.

The marine driver assist system may use a convolutional neural network to search predefined image regions, for example, the image of FIG. 4, for boats. Machine learning may be used to train the convolutional neural network based on ground truth boat detection data. In machine learning, the term “ground truth” refers to the accuracy of the training set's classification for supervised learning techniques. This may be used in statistical models to prove or disprove research hypotheses. The term “ground truthing” refers to the process of gathering the proper objective (provable) data for the test and may be similar to comparing to a gold standard. The VPU may search through an image (or frame) of a view of one or more of the cameras 46, 46.1, and 46.2 for boats or other objects. Once a boat is located in the view, the VPU may track the boat, assign an identification (ID) to the boat, and compare frame by frame positions of the boat to keep track of the position of the boat over time. In this context, “frame” may refer to an image in a sequence of images over time from one or more cameras such as one or more of the cameras 46, 46.1, and 46.2, for example. In other words, frame by frame positions of the boat are positions of the boat in respective images in a sequence of images over time. The VPU can also utilize sensor data for distance and velocity from radar 64, lidar 66, one or more of the stereo cameras 46, 46.1, and 46.2, all shown in FIG. 2, or a combination of two or more thereof, for example.

The marine driver assist system may track boats using one or more of speed and acceleration, distance, location of an object in the image, the size of an object in the image, both height and width, to estimate the physical size of a boat based on its size and an image and the measured distance to the boat.

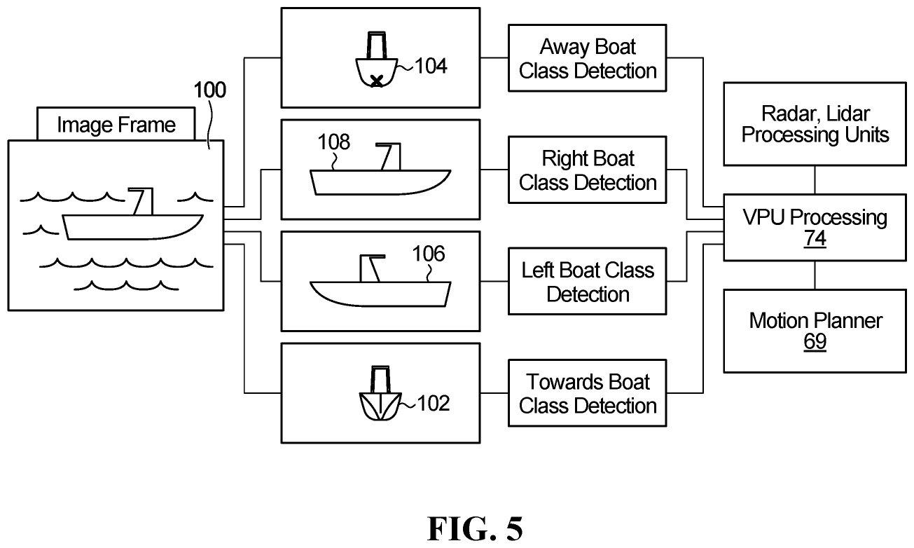

Boats may have distinctive features such as bows and sterns which can be used to train the convolutional neural network using pictures of different boats facing in different directions. For example, with reference to FIG. 5, the marine driver assist system can be trained to distinguish boats appearing in a field of view (or image frame) 100 of one or more of the cameras 46, 46.1, and 46.2, including a boat 102 coming towards the marine vessel 10 (or any other boat, which may be referred to as the subject boat, where the marine driver assist system as described herein is installed), boat 104 going away from the subject boat, boat 106 going sideways to the left of the subject boat, and boat 108 going sideways to the right of the subject boat. In this example, towards the subject boat, away from the subject boat, sideways to the left of the subject boat, and sideways to the right of the subject boat are all examples of classes of direction of movement of a boat (or other object) relative to the subject boat. However, alternative embodiments may include more, fewer, or different classes of direction of movement of a boat (or other object) relative to the subject boat. The class detected may be inputted into VPU processing 74 which may send the location and classes of detected boats to the motion planner 69 (MPU) shown in FIG. 2. The MPU may recommend actions based on the classes, location, or speed of the boat detected, or based on a combination of two or more thereof. The speed of the boat can be measured by the vision processing unit, such as the stereo camera vision processing unit 74, the lidar processing unit 72, or the radar processing unit 70, all shown in FIG. 2, or by a combination of two or more thereof.

If another boat is detected coming towards the subject boat, then the marine driver assist system may monitor the other boat and may alert the user or take collision avoidance measures with respect to the other boat as required. For example, if the other boat is detected going away from the subject boat then the subject boat can choose to follow the other boat in adaptive cruise control following application. As another example, if the other boat is going sideways to the left of the subject boat, then the VPU can choose to steer it to the right of the other boat to avoid it. As another example, if the other boat is going sideways to the right, then the VPU can choose to steer to the left of the other boat to avoid it.

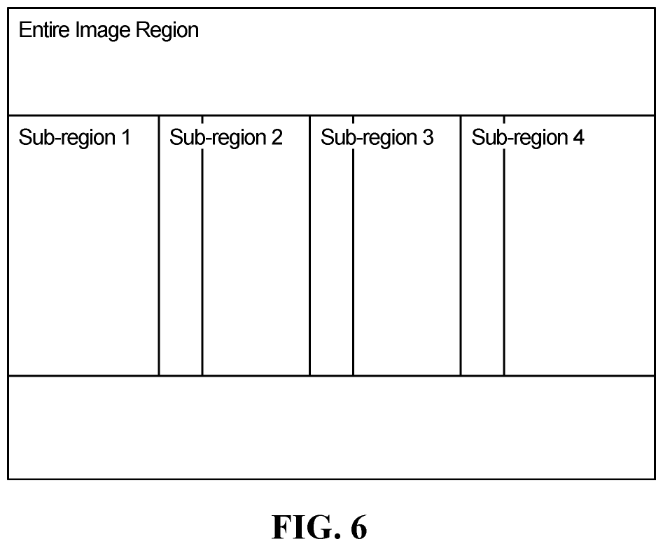

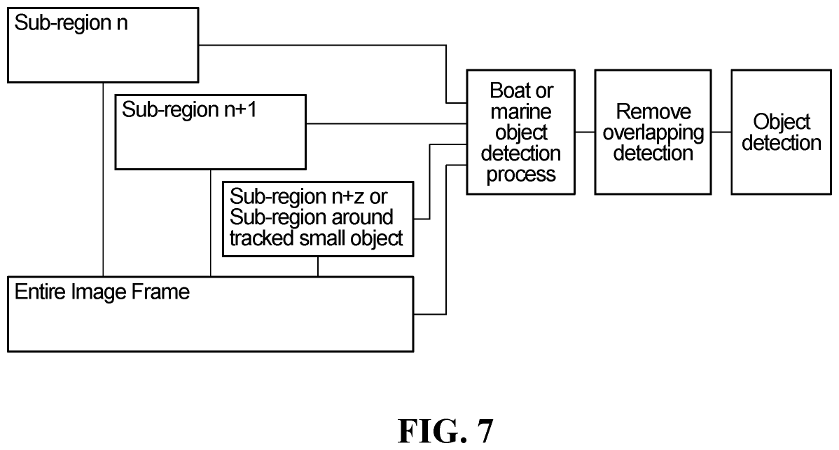

With reference to FIGS. 6 and 7, many marine objects may exist at significant distances, especially on the horizon, making their size in the image of a view of a camera relatively small so they can be hard to detect. Further, detectors (which may also be referred to as object detectors), one, more than one, or all of which may be single shot detectors, may run at real-time, and therefore may have to reduce image size (or resolution) before processing to allow for detection at real-time speeds. To mitigate this issue in detecting small objects the marine driver assist system may use a plurality of detectors, which may be identical, and which are run each cycle of a plurality of detection cycles that may be in a sequence of detection cycles over time. Each detection cycle may involve searching one frame in a sequence of images over time from one or more cameras such as one or more of the cameras 46, 46.1, and 46.2, for example. One, more than one, or all of the detectors may be implemented by a processor circuit of a driver assist system or of a data processor of the driver assist system, or otherwise by a driver assist system or by a data processor programmed, configured, or otherwise operable to implement one, more than one, or all of the detectors. One, more than one, or all of the detectors may check different dynamically selected regions in the image, and the region may have fewer pixels than the original image. Different regions may be selected at each cycle through the sequence. Some regions may be checked every cycle if they recently contained detected objects. Regions can be dynamically created and/or replaced to encompass detected objects. Such dynamic regions may track positions of objects as the objects move through water, or as the subject boat moves (for example, as the subject boat moves by roll, pitch, or otherwise in waves, or as the subject boat otherwise moves) as it travels through water. In addition, sizes of such dynamic regions may be scaled in response to the size of the object to enhance detection robustness and processing efficiency. These regions may be checked every cycle.

The marine driver assist system may search through a predefined set of regions, and may check some (but not all) of the predefined regions every cycle. When objects are detected new (or dynamic) regions may be set around them and may be checked every cycle as long as that object is still detected. Such use of predefined regions may extend detection range in an open water marine environment and may allow better detections while still using low resolution detectors with responsive performances. Such use of predefined regions may also save resources by only checking some fixed number of subregions in one cycle. Such use of dynamic searching algorithms with locking regions on detected objects is novel for marine object tracking and may allow efficient tracking of marine objects as the subject boat (and its sensors) pitch and roll in waves or otherwise move as the vessel travels through the water.

Many object detection algorithms run in real time. Inputs to such object detection algorithms may be at a relatively low resolution, e.g. 300×300 pixels, but at such low resolution, the model may struggle to detect small objects in the view. On the other hand, larger algorithms with larger resolution inputs may scale exponentially in complexity, and a processor may not have enough computation power and may struggle to complete object detection fast enough for real-time performance.

To enhance small object detection, or object detection more generally, the marine driver assist system may use a set of searching windows (or predefined subregions) in the view of one or more cameras. FIG. 6 illustrates an example of four predefined subregions within an entire view of one or more cameras (or entire image region). In general, each such predefined subregion may be a smaller region of the image where objects are expected, e.g. the horizon. The smaller region size may allow the marine driver assist system to increase an object detection size to region size ratio, which may allow the marine driver assist system to detect smaller objects. For example, if the overall image frame is 2000×2000 pixels, when it is scaled down to 300×300 resolution small objects may not be detected. However, if the subregion size is 500×500 pixels after it is scaled down to 300×300 resolution, small objects may still be detected.

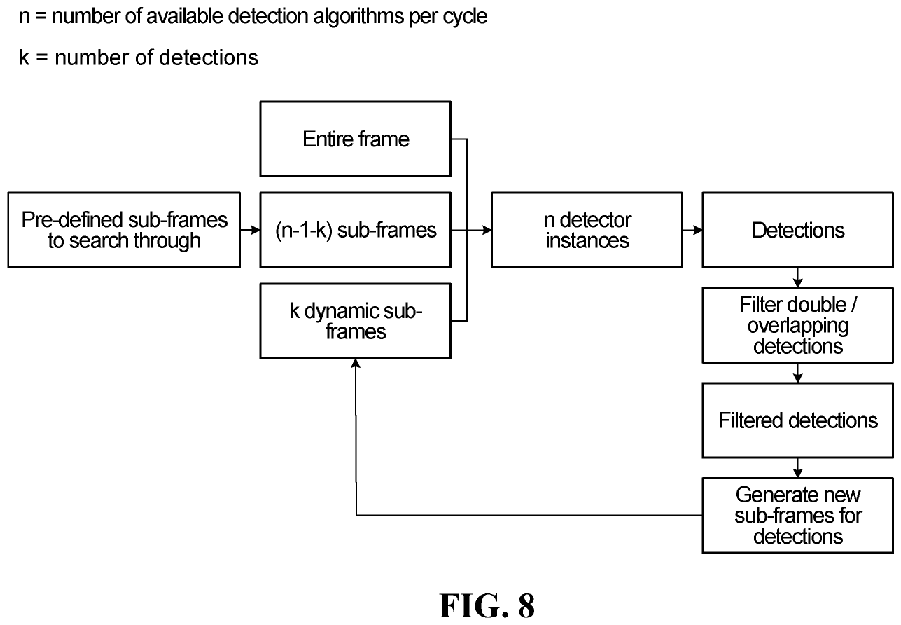

With reference to FIG. 8, the following is a description of a method for small boat detection according to one embodiment, although alternative embodiments may differ:

1. Prepare predefined subregions: (a) Consider the entire region. (b) Divide this into a series of smaller predefined subregions. (c) Evenly distribute the predefined subregions across the entire region such that they horizontally overlap and are centered vertically. They are centered vertically (or otherwise including or centered on a horizon) because the concern is small boats on the horizon.

2. Prepare dynamic subregions: (a) The dynamic subregions track boats detected only in a predefined subregion. (b) A dynamic subregion is placed so that the boat is on the edge of the dynamic subregion with some offset to allow the boat to move further into the dynamic subregion on the next cycle. (c) Boats which are not found for x cycles are dropped and the dynamic subregion is abandoned. (d) If two boats are close enough together, then one dynamic subregion is placed over both boats.

3. The processor is capable of processing N regions per cycle using N single shot detectors (SSDs), although other embodiments may include other detectors that may not necessarily be SSDs. This is comprised of: (a) The first SSD is used to detect the entire region at lower resolution. N−1 SSDs are still available. (b) Dynamic subregions are generated to monitor objects detected in previous cycles. There are K of the dynamic subregions, to a maximum of (N−1). The dynamic subregions are repeatedly created based on results of previous iterations of steps 7-9 as described below. (N−1−K) SSDs are still available. (c) All remaining processing power is used in predefined subregions. Thus (N−1−K) detectors are available to search predefined subregions.

4. Take N−1−K extra single shot detectors and feed N−1−K of M predefined subregions through the SSDs as well as entire image through the first SSD.

5. Move all the N−1−K single shot detectors to new predefined subregions every cycle such that it takes no more than ceiling(M/(N−1−K)) cycles to have a predefined subregion go through an SSD where M is the number of predefined subregions. As a result, the marine driver assist system may be configured to cause N−1−K available detectors to search only some predefined subregions in one object detection cycle, and to cause the N−1−K available detectors to search other predefined subregions in another object detection cycle.

6. Continue the cycle through the regions until a single shot detector detects the boat which is not also detected by the whole image single shot detector.

7. Then use one dynamic subregion to cover this boat. The marine driver assist system does not center the dynamic subregion on this boat, but rather places it to the edge of the boat detection with some offset to allow the boat to move in that direction frame to frame (or cycle to cycle). Some amount of spatial locality of boat detection from frame to frame (or cycle to cycle) is assumed.

8. Continue to search this dynamic subregion with the updated location of the boat as it is tracked. Boats not found for X cycles are dropped and the SSD is returned to search other regions.

9. If two boats sufficiently close to each other are detected by the SSDs of a predefined subregion, the marine driver assist system attempts to place one dynamic subregion over the boats with the buffer room. If this is not possible then two dynamic subregions are used in a nonoverlapping manner.

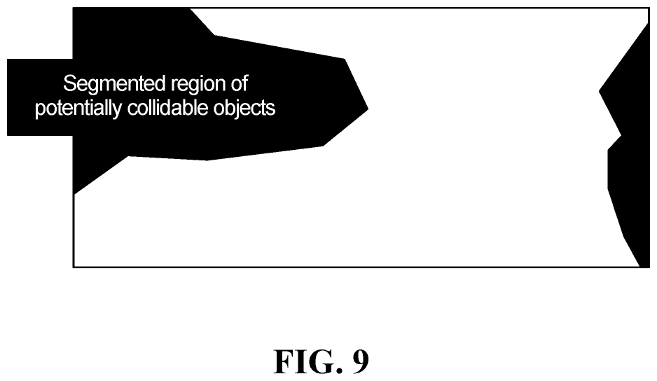

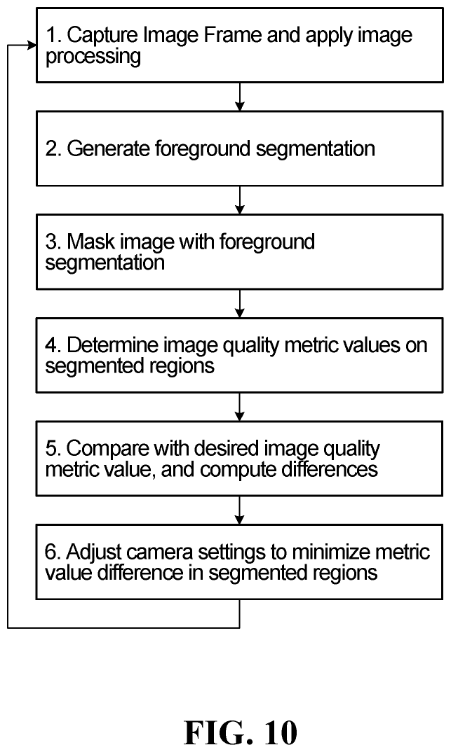

The marine driver assist system may also employ smart brightness adjustment as seen in FIGS. 9 and 10, for example. Image analysis of the relevant foreground and objects requires a minimum level of image quality, e.g. brightness, contrast, white balance, and exposure. Algorithms for dynamic camera settings which consider the entire image may not be usable in a marine environment when the water and sky are extremely bright. By extracting the foreground to the extent possible the image quality in this region can be enhanced.

In FIG. 9 the black regions represent the segmented regions of the image that are determined to be the foreground. The white regions represent the segmented regions of the image that are deemed to only contain background information, i.e., water or sky. The black regions (that is, the regions that are not water or sky) may then be used exclusively for considerations of how the camera and processing settings should be changed.

With reference to FIG. 10, the following is a description of a method for dynamically adjusting camera settings based on segmented foreground information in an image according to one embodiment, although alternative embodiments may differ:

1. Capture camera image and apply digital processing such as contrast or edge enhancement to the image to make some compensations and enhancements.

2. Through the use of a convolutional neural network, determine and generate foreground segmentation on the image. The foreground regions contain objects of interest for advanced driver assist functions (e.g. boats, docks, buoys) and does not contain the background region of image such as sky or water. The foreground regions may be identified as regions that are not water or sky.

3. Mask the image obtained from step 1 with the foreground segmentation from step 2. This step provides a masked image that contains only the foreground regions. The foreground information is illustrated as an example in FIG. 9 as the black regions.

4. Analyze the masked regions from step 3 and determine the image quality metrics for those regions. Examples of image quality metrics include brightness, contrast, hue, saturation, exposure, and white balance, any one thereof, or a combination of any two or more thereof. The background region is ignored in the analysis.

5. Compare the image quality metrics values of the masked regions from step 4 against desired quality metric values, and compute the difference.

6. Adjust camera settings for the masked regions from step 3 by minimizing the computed metric difference in step 5.

Continue to iterate through steps 1 through 6 for each image frame or detection cycle.

Camera settings may be compensated with every frame or detection cycle, which may ensure even foreground quality even though the image transitions into and away from areas with bright backgrounds. This may give the marine driver assist system the ability to tolerate a large range of lighting conditions within the background of an image without degrading performance of the marine driver assist system. The new contribution of this method is using segmented foreground apart from water or sky areas to isolate regions considered for compensation of the camera and postprocessing settings to enhance only regions of interest in outdoor applications.

Embodiments of this disclosure may include sensor fusion. Different types of sensors have different attributes and are better at different things. Cameras may be good at recognition and classification. Radar may be good at measuring velocity and position and is not affected by bad weather. Stereo cameras can be used to measure distance to objects. However, radar may have a higher accuracy in measuring medium to long range distance. Lidar may be preferable to measure short to medium range distance.

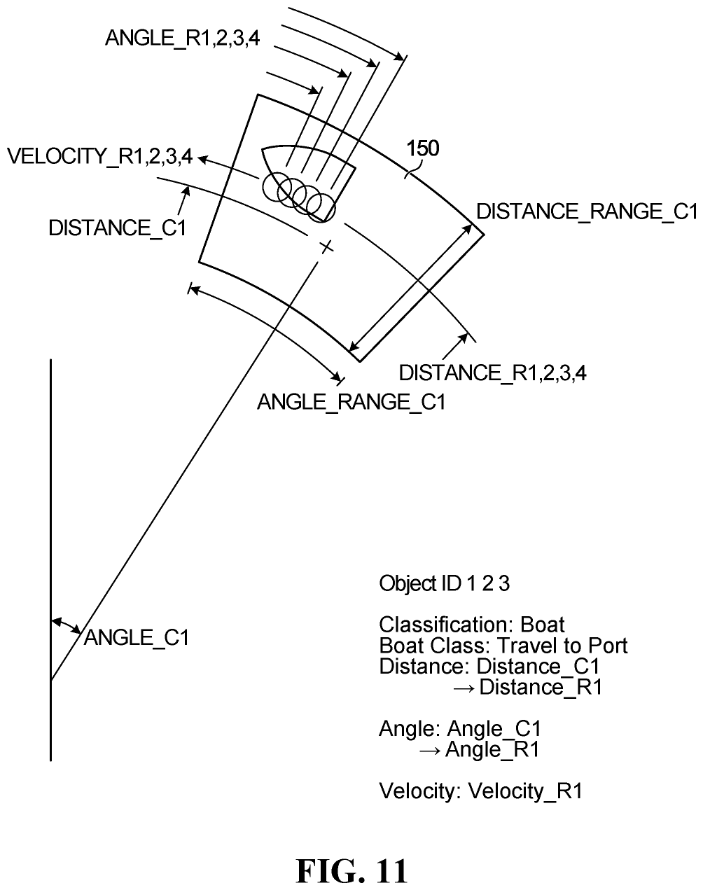

Referring to FIG. 11, a camera may be primarily used to identify and classify objects via segmentation as described above. Radar or lidar may be primarily used to measure distance, velocity, or angle, or a combination of two or more thereof, of an object. The sensor fusion module, shown in FIG. 1, may use the camera rough distance and angle information and may refine the actual distance and angle from the radar or lidar. For example, the processing unit with camera data may define a zone of the identified object, e.g. object ID 123 with classification of boat, a boat class of travel to port, a normal distance of Distance_C1, a distance range of Distance_Range_C1, a nominal angle Angle_C1, and an angle range of Angle_Range_C1. The range is based on the inaccuracy and confidence level of the object from the camera vision processing unit. The range of distance and the angle define a two-dimensional camera zone 150 in plan view. The letter “C” refers to the camera-based measurement. The radar processing unit with radar data defines the location of an object with multiple point clouds, e.g. 4 point clouds, distance Distance_R1, 2, 3, 4, angle Angle_R1, 2, 3, 4, and velocity Velocity_R1, 2 , 3, 4. The letter “R” refers to the radar-based measurement. The sensor fusion module may find the best match among the camera zones and radar point cloud locations. Based on a set point of point cloud locations, the sensor fusion controller may find the closest, computational match within the zone to label the identified object. Such sensor fusion may upgrade the accuracy of the locations of identified objects and added velocity information. Sensor fusion according to alternative embodiments may differ.

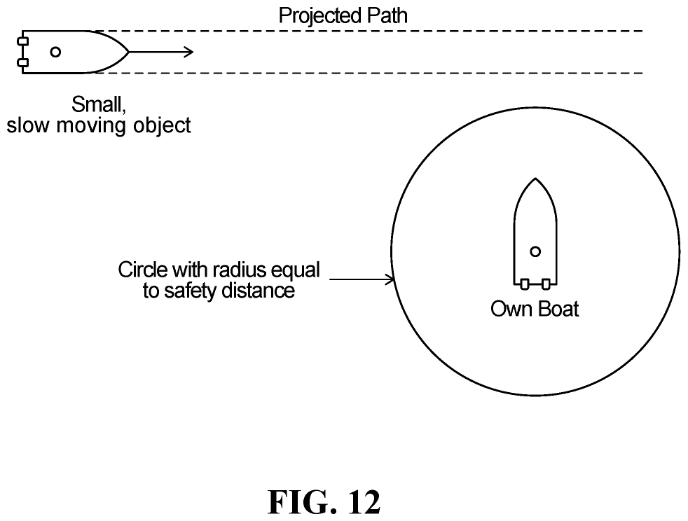

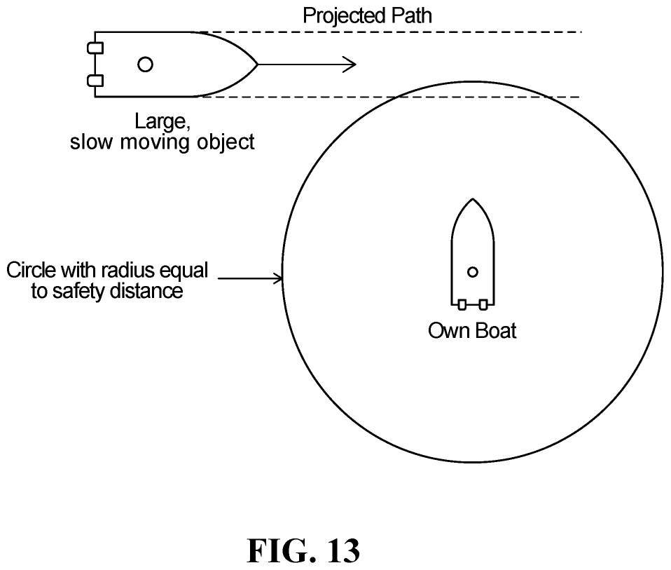

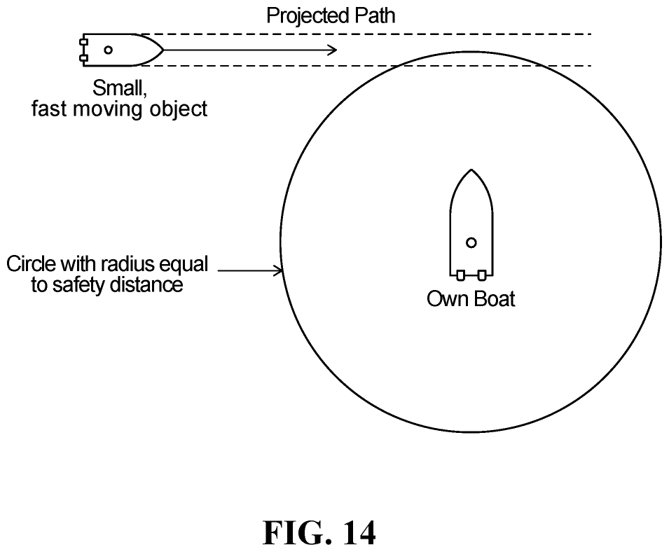

FIGS. 12-15 relate to vessel control and, in particular, to collision avoidance according to some embodiments of this disclosure. The marine driver assist system may constantly monitor surroundings to determine if the subject vessel is on a collision course with any object (such as another boat or another object). As stated previously, anything that is deemed not to be water or sky is deemed to be a potentially collidable object. The subject boat (the boat where the marine driver assist system is installed) and an object may be on a collision course if the object's motion vector relative to the subject boat results in its distance from the subject boat being less than a predetermined safe distance at any time. The safe distance may be programmable and may vary, for example depending on the size and absolute speed of both the subject boat and the object. See the examples in FIGS. 12-14. FIG. 12 is an example of a small, slow-moving object approaching the subject boat from the front. FIG. 13 is an example of large object passing the subject boat. The safety distance is larger in this case due to the object's larger size. Part of the object will enter the safe distance and thus collision is predicted. FIG. 14 is an example of a small, fast-moving object approaching the subject boat from the front. Alternative embodiments may differ from the examples of FIGS. 12-14.

Where there is risk of collision from the forward direction of the boat, thrust may be reduced according to a control algorithm considering the collidable object's distance and relative velocity. If the control algorithm requests zero thrust, the boat is still moving, and the collidable object is within the safe distance, “brakes” may be applied. The duration and intensity of braking may be based upon a control algorithm considering the object's distance and the subject boat's speed.

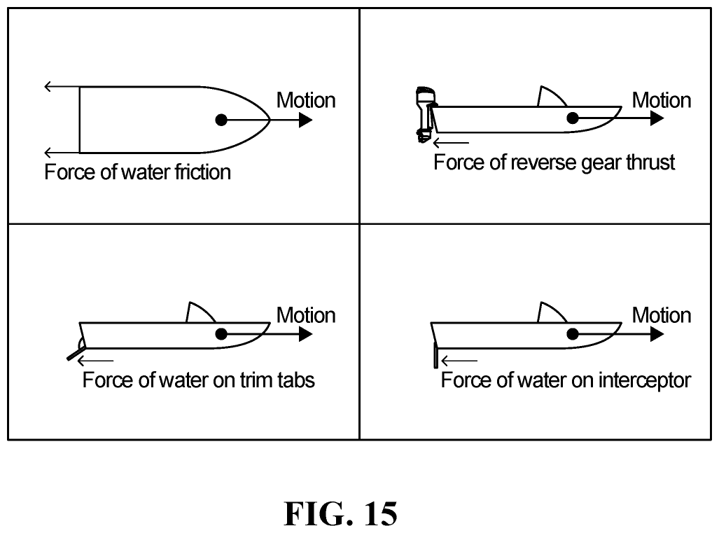

Since boats have significant momentum and no conventional brakes, a series of other mechanisms may be used to accomplish braking. A number of options may be available and may be used in any combination including friction from passing water, shifting out of gear, shifting into reverse gear, deploying the trim tabs, and deploying interceptor tabs as illustrated in FIG. 15. Alternative embodiments may include alternatives to the examples illustrated in FIG. 15.

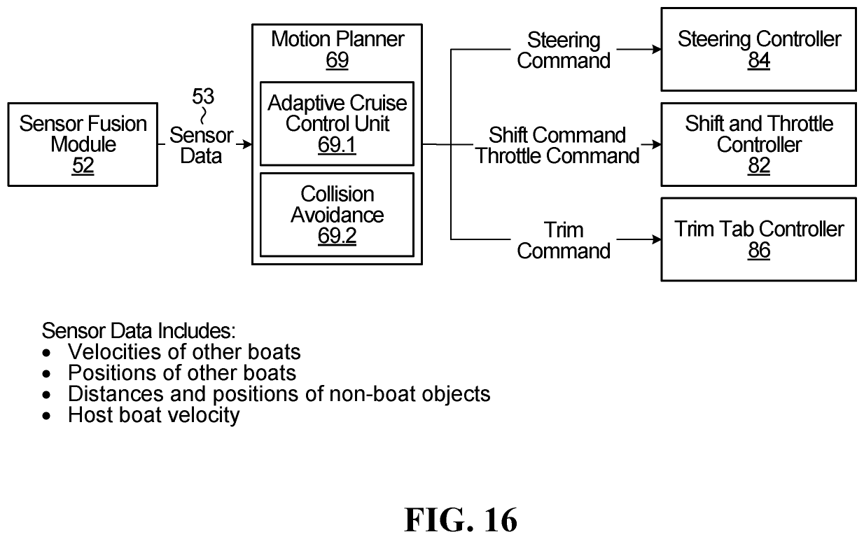

FIG. 16 shows the motion planner 69 according to one embodiment with subunits inside the motion planner including an adaptive cruise control unit 69.1 and a collision avoidance unit 69.2. Although the embodiment shown includes the adaptive cruise control unit 69.1 and the collision avoidance unit 69.2 inside the motion planner, alternative embodiments may vary, and various different functions of the motion planner 69 may be implemented in the same device, such as a device including one processor circuit, or in one or more separate devices other implementations that may be programmed, configured, or otherwise operable to implement some or all functions as described herein. For example, in some embodiments, the adaptive cruise control unit 69.1 and the collision avoidance unit 69.2 may be implemented in separate processor circuits or in multiple separate devices that may be programmed, configured, or otherwise operable to implement some or all functions as described herein.

The motion planner may receive sensor data 53 from the sensor fusion module 52 or 68. The sensor data may include velocities of other boats, positions of other boats, distances positions, or both of non-boat objects, velocity of the subject boat (the boat where the marine driver assist system is installed), or a combination of two or more thereof. The motion planner may communicate with a steering controller 84, shift and throttle controller 82, and trim tab controller 86 and may provide them with steering commands, shift and throttle commands, and trim commands respectively.

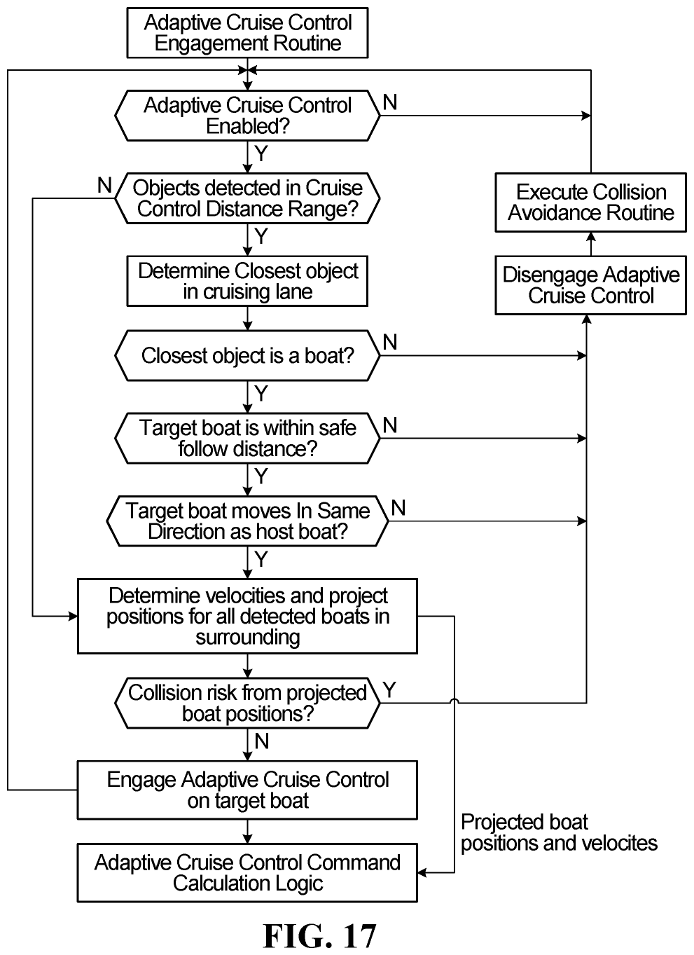

FIG. 17 is a block diagram which describes an adaptive cruise control engagement routine for an adaptive cruise control unit or system for a boat according to one embodiment of this disclosure. In this context it should be noted that requirements of adaptive cruise control for a marine vessel are considerably different than the characteristics of a typical cruise control in automobiles. In automobiles, adaptive cruise control may adjust vehicle speed to help maintain a preset distance from a preceding vehicle when the preceding vehicle is travelling at a lower speed. When the marine driver assist system determines that the road ahead is clear, adaptive cruise control for a vehicle may automatically increase the speed of the vehicle back to its preset speed. Vehicles on roads may have well defined rules. Vehicle lanes on roads may be well defined. Vehicles travelling in the same direction usually have similar speeds. Adaptive cruise control systems in cars only need to follow the preceding vehicle, when there is one, and does not have to monitor oncoming vehicles from opposite lanes or coming from different directions which come too close. There are fewer interruptions to stop adaptive cruise control systems in cars compared to boats.

The adaptive cruise control unit or system for boats, according to an embodiment of this disclosure, may engage when following a preceding boat within a preset distance. However, other boats in a marine environment can come from different locations and can change course more suddenly compared to automobiles on a road. Also boats have inertia but no actual brakes. It may take much longer for a boat to stop or change course, particularly large boats, compared to automobiles on a road. Also boats may not travel within defined lanes and may travel in a staggered pattern even when travelling in a similar direction. Also boats travelling in a similar direction may do so at different speeds. Low-speed adaptive cruise control can be engaged in a busy waterway or marina where oncoming boats may come too close. Adaptive cruise control/collision avoidance systems may need to work together to reduce speed or stop the subject boat if necessary. There may be more interruptions to stop adaptive cruise control systems in boats compared to cars. It may be advantageous to automatically reengage adaptive cruise control for a boat if it is interrupted. The following numbered steps characterize the operation of the adaptive cruise control for boats according to one embodiment, although alternative embodiments may differ.

1. With reference to FIG. 17, if adaptive cruise control is enabled it will determine whether there are objects within an adaptive cruise control range. If there are such objects, then the adaptive cruise control unit or system proceeds with step 2 below. If no such objects are detected, then the adaptive cruise control unit or system skips to step 6 below.

2. Where there are objects in the adaptive cruise control range, the adaptive cruise control unit or system then determines whether the closest object is a boat.

3. Where the closest object is determined to be a boat, the adaptive cruise control unit or system determines whether this is within a safe following distance (i.e. it is not too close such that it may cause a crash).

4. The adaptive cruise control unit or system then checks whether the preceding boat is travelling in the same general direction as the subject boat.

5. If the answer to step 2 was “no”, and the closest object is not a boat, then the closest object may be an obstacle such as a rock. If the answer to step 3 was “no”, then the subject boat may be too close to the preceding boat such that it may have a risk of crashing with it. If the answer to step 4 is “no” then the closest boat may be travelling towards the subject boat. When the answer to any of the steps 2, 3 or 4 is “no” then the adaptive cruise control will disengage and execute the collision avoidance routine to mitigate the risk of collision.

6. Before engaging cruise control command, the adaptive cruise control unit or system will utilize its sensor data (e.g. radar, stereo camera, or lidar data) to determine velocities and positions of all detected boats. The adaptive cruise control unit or system then uses the present position and velocity of each boat to project its future position.

7. If the projected future position of any boat indicates a risk of collision, then the adaptive cruise control will also disengage and collision avoidance will execute.

8. Where there is no risk of collision, then adaptive cruise control will be engaged and locked onto the target boat as a target.

9. The projected boat positions and velocities of the preceding boat and surrounding boats are used to calculate the adaptive cruise control commands for steering, shift and throttle and trim tab controllers.

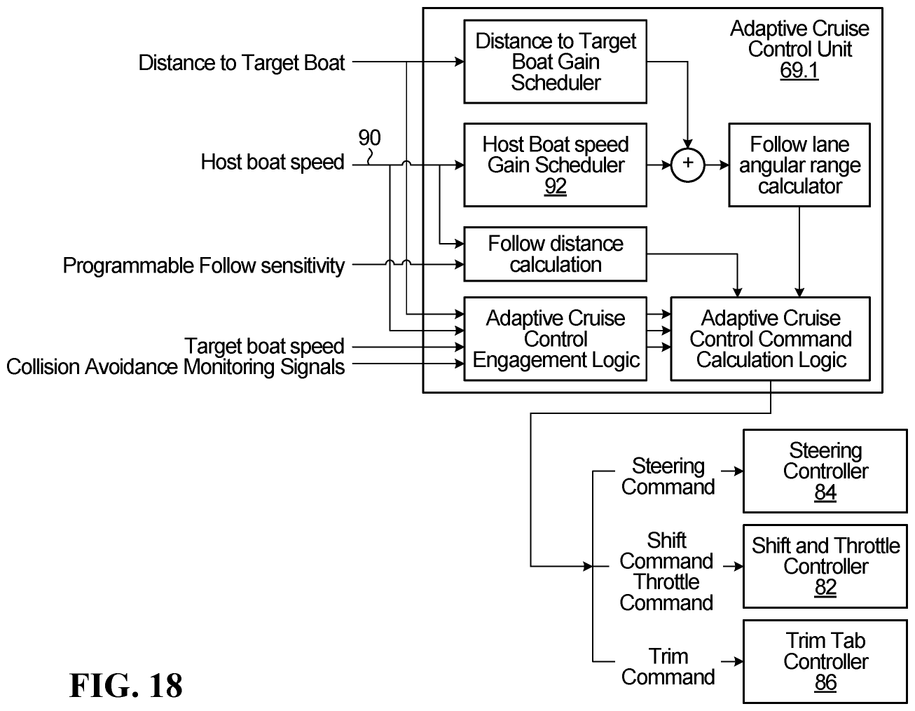

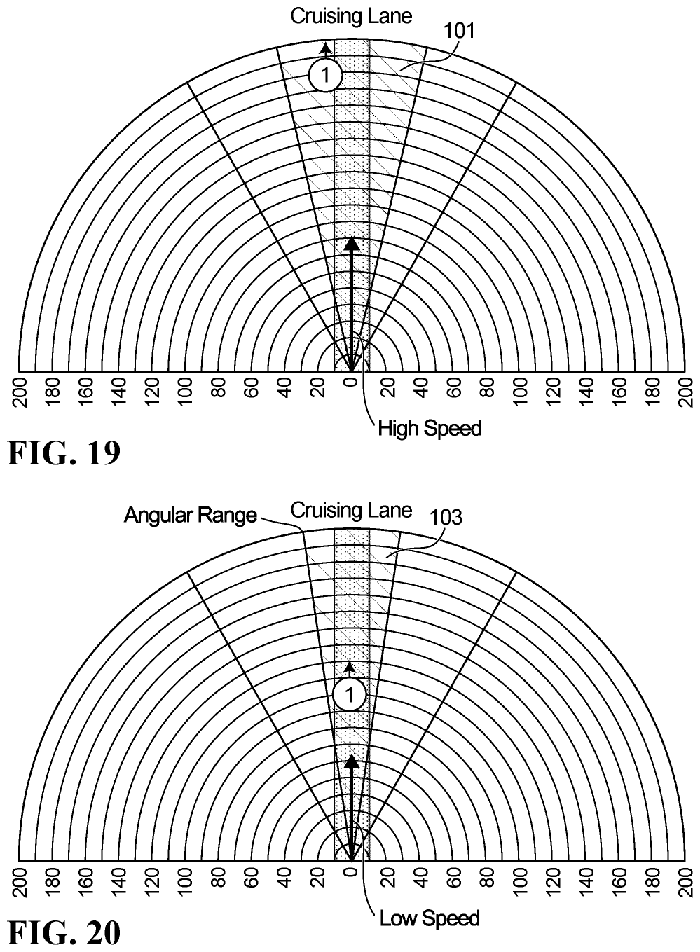

With reference to FIGS. 18-20, the angular range is proportional to (the subject boat speed 90×a gain factor may be calculated by a programmable distance gain scheduler 92). For example, when the subject boat is travelling at a higher speed, as illustrated in FIG. 19, the angular range 101 of the adaptive cruise control is larger compared with the situation shown in FIG. 20 where the subject boat is travelling at a lower speed and the angular range 103 is smaller. Likewise, when the target boat is further away, as shown in FIG. 19, the adaptive cruise control angular range is larger than when the target boat is closer as shown in FIG. 20. The distance set to follow the target boat is dependent on user programmable follow sensitivity and the speed of the subject boat. Alternative embodiments may differ from the examples of FIGS. 19 and 20.

It will be understood by someone skilled in the art that many of the details provided above are by way of example only and are not intended to limit the scope of the invention which is to be determined with reference to the following claims.

1. A driver-assist system for a marine vessel, the system comprising:
a camera operable to obtain data comprising images of a view of the camera; and
a data processor programmed to, at least, distinguish between:
portions of the view representing water and/or sky; and
a portion of the view representing an object.

2. The system of claim 1 wherein the data processor is further programmed to, at least, utilize machine learning trained to identify water, sky, and anything that is not water or sky.

3. The system of claim 1 wherein the data processor is further programmed to, at least, utilize a convolutional neural network trained to identify water, sky, and anything that is not water or sky.

4. The system of claim 1, 2, or 3 wherein the data processor is further programmed to, at least, identify the object as anything that is not sky or water.

5. The system of claim 1, 2, 3, or 4 wherein the data processor is further programmed to, at least, adjust settings of the camera only according to image quality metrics values of only portions of the view not representing water and/or sky.

6. The system of any one of claims 1 to 5 wherein the data processor is further programmed to, at least, identify a horizon in the view.

7. The system of claim 6 wherein the data processor is programmed to identify the object near the horizon.

8. The system of any one of claims 1 to 7 wherein the data processor is further programmed to, at least, detect the object by, at least, causing at least some object detectors of a plurality of object detectors to search for objects only in respective different subregions of a plurality of different subregions of the view.

9. The system of claim 8 wherein the data processor is further programmed to, at least, cause the at least some object detectors to search for objects only in portions of the view not representing water and/or sky.

10. A driver-assist system for a marine vessel, the system comprising:
a camera operable to obtain data comprising images of a view of the camera; and
a data processor programmed to, at least, detect an object by, at least, causing at least some object detectors of a plurality of object detectors to search for objects only in respective different subregions of a plurality of different subregions of the view.

11. The system of claim 8, 9, or 10 wherein the data processor is further programmed to, at least, implement the plurality of object detectors.

12. The system of claim 8, 9, 10, or 11 wherein at least one object detector of the plurality of object detectors is a single-shot detector (SSD).

13. The system of any one of claims 8 to 12 wherein the plurality of subregions comprises a plurality of different predefined subregions.

14. The system of claim 13 wherein the predefined subregions of the plurality of predefined subregions are distributed evenly across the entire view.

15. The system of claim 13 or 14 wherein the predefined subregions of the plurality of predefined subregions overlap horizontally.

16. The system of claim 13, 14, or 15 wherein the predefined subregions of the plurality of predefined subregions are centered vertically within the view.

17. The system of claim 13, 14, 15, or 16 wherein the data processor is further programmed to, at least:
cause available object detectors of the plurality of object detectors to search only some predefined subregions of the plurality of predefined subregions in a first object detection cycle; and
cause the available object detectors of the plurality of object detectors to search other predefined subregions of the plurality of predefined subregions in a second object detection cycle after the first object detection cycle.

18. The system of any one of claims 8 to 17 wherein the data processor is further programmed to, at least, cause at least one object detector of the plurality of object detectors to search for objects in a dynamic subregion of the plurality of subregions, the dynamic subregion placed such that the object is within the dynamic subregion.

19. The system of claim 18 wherein the data processor is further programmed to, at least, cause the dynamic subregion to move in response to movement of the object.

20. The system of claim 18 or 19 wherein the data processor is further programmed to, at least, cause the dynamic subregion to have a size in response to a size of the object.

21. The system of any one of claims 8 to 20 wherein the data processor is further programmed to, at least, cause at least one object detector of the plurality of object detectors to search for objects in the entire view.

22. The system of any one of claims 8 to 21 wherein each object detector of the plurality of object detectors, in operation, detects objects at a resolution smaller than a resolution of the images.

23. The system of any one of claims 1 to 22 wherein the data processor is further programmed to, at least, alert a user in response to detecting the object.

24. The system of any one of claims 1 to 23 wherein the system is programmed to, at least, take collision avoidance measures in response to detecting the object.

25. The system of claim 24 wherein the system is programmed to take the collision avoidance measures by, at least, preventing the object from being less than a safety distance at any time from the marine vessel.

26. The system of claim 25 wherein the system is programmed to, at least, vary the safety distance according to, at least, a size of the marine vessel.

27. The system of claim 25 or 26 wherein the system is programmed to, at least, vary the safety distance according to, at least, a speed of the marine vessel.

28. The system of claim 25, 26, or 27 wherein the system is programmed to, at least, vary the safety distance according to, at least, a size of the object.

29. The system of claim 25, 26, 27, or 28 wherein the system is programmed to, at least, vary the safety distance according to, at least, a speed of the object.

30. The system of any one of claims 1 to 29 wherein the data processor is further programmed to, at least, identify a distance from the system to the object.

31. The system of claim 30 wherein the data processor is programmed to identify the distance from the system to the object according to, at least, radar data from a radar apparatus.

32. The system of claim 30 or 31 wherein the data processor is programmed to identify the distance from the system to the object according to, at least, lidar data from a lidar apparatus.

33. The system of claim 30 wherein the data processor is programmed to identify the distance from the system to the object according to, at least, data from a sensor separate from the camera.

34. The system of any one of claims 1 to 33 wherein the data processor is further programmed to, at least, identify a speed of the object.

35. The system of claim 34 wherein the data processor is programmed to identify the speed of the object according to, at least, radar data from a radar apparatus.

36. The system of claim 34 or 35 wherein the data processor is programmed to identify the speed of the object according to, at least, lidar data from a lidar apparatus.

37. The system of claim 34 wherein the data processor is programmed to identify the speed of the object according to, at least, data from a sensor separate from the camera.

38. The system of any one of claims 1 to 37 wherein the data processor is further programmed to, at least, identify a direction of movement of the object.

39. The system of any one of claims 1 to 38 wherein the data processor is further programmed to, at least, identify a size of the object.

40. The system of any one of claims 1 to 39 wherein the object is a detected boat.

41. A driver-assist system for a marine vessel, the system comprising:
a camera operable to obtain data comprising images of a view of the camera; and
a data processor programmed to, at least, detect a detected boat in the view.

42. The system of claim 40 or 41 wherein the data processor is further programmed to, at least, identify a direction of movement of the detected boat from a shape of the detected boat.

43. The system of claim 42 wherein the shape of the detected boat comprises a bow of the detected boat.

44. The system of claim 42 or 43 wherein the shape of the detected boat comprises a stern of the detected boat.

45. The system of claim 42, 43, or 44 wherein the data processor is further programmed to, at least, identify one of a plurality of different classes of direction of movement in response to, at least, the direction of movement of the detected boat.

46. The system of claim 42, 43, 44, or 45, when dependent from claim 24, wherein the system is programmed to take the collision avoidance measures in response to, at least, the direction of movement of the detected boat.

47. The system of any one of claims 40 to 46 wherein the system is programmed to, at least, cause the marine vessel to follow the detected boat.

48. The system of any one of claims 40 to 47 wherein the system is programmed to, at least, cause the marine vessel to follow the detected boat at a set distance.

49. The system of claim 48 wherein the system is programmed to, at least, set the set distance according to, at least, a user-programmable follow sensitivity.

50. The system of claim 48 or 49 wherein the system is programmed to, at least, set the set distance according to, at least, a speed of the marine vessel.

51. A driver-assist system for a marine vessel, the system comprising:
a sensor operable to obtain data from surroundings of the sensor; and
a data processor programmed to, at least, cause the marine vessel to follow a detected boat.

52. The system of claim 51 wherein the sensor is a camera, and wherein the data comprise images of a view of the camera.

53. The system of any one of claims 47 to 52 wherein the data processor is programmed to cause the marine vessel to follow the detected boat only if the detected boat is a closest object detected by the system within an adaptive cruise control range.

54. The system of any one of claims 47 to 53 wherein the data processor is programmed to cause the marine vessel to follow the detected boat only if the detected boat is at least a safe-following distance of the from the marine vessel.

55. The system of any one of claims 47 to 54 wherein the data processor is programmed to cause the marine vessel to follow the detected boat only if the detected boat is moving in a same general direction as the marine vessel.

56. The system of any one of claims 47 to 55 wherein the data processor is programmed to cause the marine vessel to follow the detected boat only if the system does not detect any risk of collision with other boats detected by the system.

57. The system of any one of claims 47 to 56 wherein the data processor is programmed to cause the marine vessel to follow the detected boat only if the system does not detect any objects, other than the detected boat, within a safety region.

58. The system of claim 57 wherein the safety region is a safety circle.

59. The system of claim 57 or 58 wherein the data processor is programmed to cause the marine vessel to resume following the detected boat automatically in response to detecting no objects, other than the detected boat, within the safety region.

60. A marine vessel comprising the system of any one of claims 1 to 59.
